(19) United States
(12) Patent Application Publication
(10) Pub. No.: US 2002/0131374 A1
(43) Pub. Date: Sep. 19, 2002

(54) Intelligent telecommunications management network (TMN)

(75) Inventor: Johnathaun D. Lee, Boca Raton, FL (US)

Correspondence Address: Siemens Corporation, Intellectual Property Department, 186 Wood Avenue South, Iselin, NJ, 08830, US

(73) Assignee: Siemens Information and Communications Networks, Inc.

(21) Appl. No.: 10/007,914

(22) Filed: Nov. 8, 2001

Related U.S. Application Data
(63) Continuation of application No. 09/197,983, filed on Nov. 23, 1998, now abandoned.

(51) Int. Cl. H04L 12/28

(52) U.S. Cl. 370/254; 370/469

(57) ABSTRACT

A Telecommunications Management Network TMN system is described that utilizes Adaptive Enterprise Management techniques to create an intelligent TMN. In particular, according to one characterization of the invention, neural objects; fuzzy logic servers; artificial intelligence servers; and the introduction of an Abstract Intelligence Stratum (AIS) into the TMN model, create the intelligent TMN. According to one embodiment of the invention, the intelligent TMN platform, comprises a multilayer TMN platform, and means for providing cross-boundary analytical services and knowledge domains in the multilayer TMN platform. The means for providing cross-boundary analytical services and knowledge domains in the multilayer TMN platform is the aforementioned AIS. The invention may alternatively be characterized as an intelligent TMN, comprising a multilayer TMN platform; and means for providing an integrated set of services utilized by all layers in the TMN platform in support of applications operating at each individual layer. The means for providing the integrated set of services is defined, according to the invention, as Advanced Intelligent Analysis Services (AIAS).

### BACKGROUND OF THE INVENTION

1. Field of the Invention

The invention relates generally to Telecommunications Management Networks (TMNS) such as, for example, TMNs for managing telephony, internet, cable or wireless communications systems.

More particularly, the invention relates to performing Adaptive Enterprise Management (AEM) functions in a TMN platform to thereby create an intelligent TMN.

2. Brief Description of the Prior Art

The telecommunications industry is undergoing a radical change by which services are rendered. More sophisticated and complex data, video, internet, GSM, messaging and telephony services, are quickly migrating to different delivery media and transport technologies.

With these prolific advances, management platforms are required to support the administration of future dynamic complex services. Providers of complex service solutions, must be able to offer and successfully deploy enhanced platforms that support service providers whose customers offer complex and across market products.

TMN's themselves are well known and are utilized, for example, to manage many types of communications systems applications including, for example, the aforementioned telephony, internet, cable and wireless communications systems.

Via industry publications, journals, and international conferences, leading TMN product vendors and the major carriers have searched for an “industrial strength” TMN platform to solve such problems as (a) the present day lack of a seamless/effortless integration strategy and solution for mission and business critical applications in a TMN model; and (b) the realization of return on investment (ROI) on staff and process modifications required to implement TMN and a robust and open Applications Program Interface (API) that supports a TMN messaging framework.

Drastic advances in technology continue to force design of “best-in-class’ point applications to expand their core functionality to include an open system paradigm. An API is no longer a value-added feature, rather it is a requirement.

Presently, operation managers integrate multiple applications to achieve an environment suited to support their business. When multiple applications are integrated, the total solution is often not the full featured environment desired. The integration effort robs each system of some of its features.

Even in an integrated environment, every application operates independent of the other to gather data, process data and storing information.

Presently, no TMN products or solutions exist that provides a methodology that renders the following:

1. Complete interoperability;

2. intelligent analytical processing;

3. Advancement message management;

4. Leaning algorithms; and

5. “Living” objects that are by definition capable of learning.

Adaptive Enterprise Management (AEM), to be explained in greater detail hereinafter, provides these components. Furthermore, implementing AEM in a TMN would create an intelligent TMN exhibiting the following advantages and features:

1. Dynamic and real-time trend analysis capabilities;

2. Automatic service creation and analysis;

3. Complete system independence for integration;

4. A real time data analysis capability;

5. A complete open system environment;

6. A complete integrated message and communication framework and infrastructure;

7. Executive management summaries of business objects, current services and revenue correlation;

8. Correlation across TMN disciplines; and

9. Means for providing developers and system integrators with an open environment where the aforementioned “best-in-class” applications can be seamlessly integrated.

### SUMMARY OF THE INVENTION

Accordingly, it is a principal object of the invention to provide an intelligent TMN.

It is a further object of the invention to provide TMNs that implement AEM techniques to provide the desired intelligence.

It is still a further object of the invention to provide TMN products and solutions that facilitate complete interoperability; intelligent analytical processing; advancement message management; and include learning algorithms coupled with the use of “Living” objects (objects that are, by definition, capable of learning) to provide the desired TMN intelligence.

Further still, it is an object of the invention to provide an intelligent TMN that includes dynamic and real-time trend analysis capabilities; automatic service creation and analysis; complete system independence for integration; a real time data analysis capability; a complete open system environment; a complete integrated message and communication framework and infrastructure; Executive management summaries of business object, current services and revenue correlation; correlation across TMN disciplines; and means for providing developers and system integrators with an open environment where the aforementioned “best-in-class” applications can be seamlessly integrated.

In order to solve the aforementioned problems with present day TMN systems and to realize the aforestated objects, the invention utilizes, according to a first embodiment thereof, evolutionary enhancements to the well known internal TMN model. The enhancements involve the implementation of artificial intelligence and fuzzy logic into the TMN model, specifically involving the use of (a) neural objects; (b) fuzzy logic servers; (c) artificial intelligent servers; and (d) the introduction of an Abstract Intelligence Stratum into the TMN model.

The invention may be further characterized, according to a second embodiment thereof, as an intelligent Telecommunications Management Network (TMN) platform, comprising (a) a multilayer TMN platform; and (b) means for providing cross-boundary analytical services and knowledge domains in the multilayer TMN platform. This means is defined, according to the invention, as the Abstract Intelligent Stratum (AIS).

According to this second embodiment of the invention, the means for providing cross-boundary analytical services and knowledge domains in the multilayer TMN platform (a) utilizes neuro-object elements which are capable of learning; and (b) further comprises an abstract intelligent stratum within the TMN platform which provides context between the layers in an environment which associates multiple rules and objects.

Still further, the second embodiment of the invention may be further characterized as including means for providing a seamless open platform without loss of functionality, wherein the means for providing the seamless open platform further comprises an impulse communications messaging system.

The impulse communications messaging system (to be described in greater detail hereinafter) is, according to an illustrative embodiment of the invention, a dual level, peer to peer messaging system that receives and delivers messages utilizing neuro-object elements and neuro message cells (to be defined hereinafter), capable of carrying specific data or transaction content.

The invention may be further defined, according to a third characterization thereof, as an intelligent Telecommunications Management Network (TMN), comprising (a) a multilayer TMN platform; and (b) means for providing an integrated set of services utilized by all layers in the TMN platform in support of applications operating at each individual layer. This means is defined, according to the invention, as means for providing Advanced Intelligent Analysis Services (AIAS).

The means for providing an integrated set of services, according to this third embodiment of the invention, further comprises: (a) a centralized Advanced Intelligent Analysis Services (AIAS) database; and (b) an analytical processor.

The means for providing an integrated set of services further comprises, according to third embodiment of the invention, a family of intelligent elements including a plurality of intelligent object request brokers; at least one fuzzy logic operating system; a plurality of analytical servers (e.g. Artificial Intelligence servers); and a set of interaction rules.

The means for providing an integrated set of services further comprises means for creating data and experience images; and the intelligent TMN described in the third embodiment of the invention also includes a set of neuro-object elements which are capable of learning.

The invention realizes the aforestated objects. Furthermore, the invention provides the advantage of enabling multiple heterogeneous systems to be integrated using an intelligent TMN platform.

The aforementioned embodiments of the invention as well as other embodiment thereof will be described hereinafter in the detailed description of the invention with reference to the Drawing.

### BRIEF DESCRIPTION OF THE DRAWINGS

FIG. 1 depicts the location in a TMN model where the Abstract Intelligent Stratum contemplated by the invention would logically be implemented.

FIG. 2 depicts centralized and decentralized AIAS elements interfacing to provide the performance platform contemplated by the invention. FIG. 2 specifically shows an AIAS component implemented at each TMN layer in the depicted model.

FIG. 3 depicts an example of the sharing of information among neuro-objects in accordance with the teachings of the invention.

FIG. 4 depicts an example of the life span of a neuro-object created from an unsolicited alarm.

### DETAILED DESCRIPTION

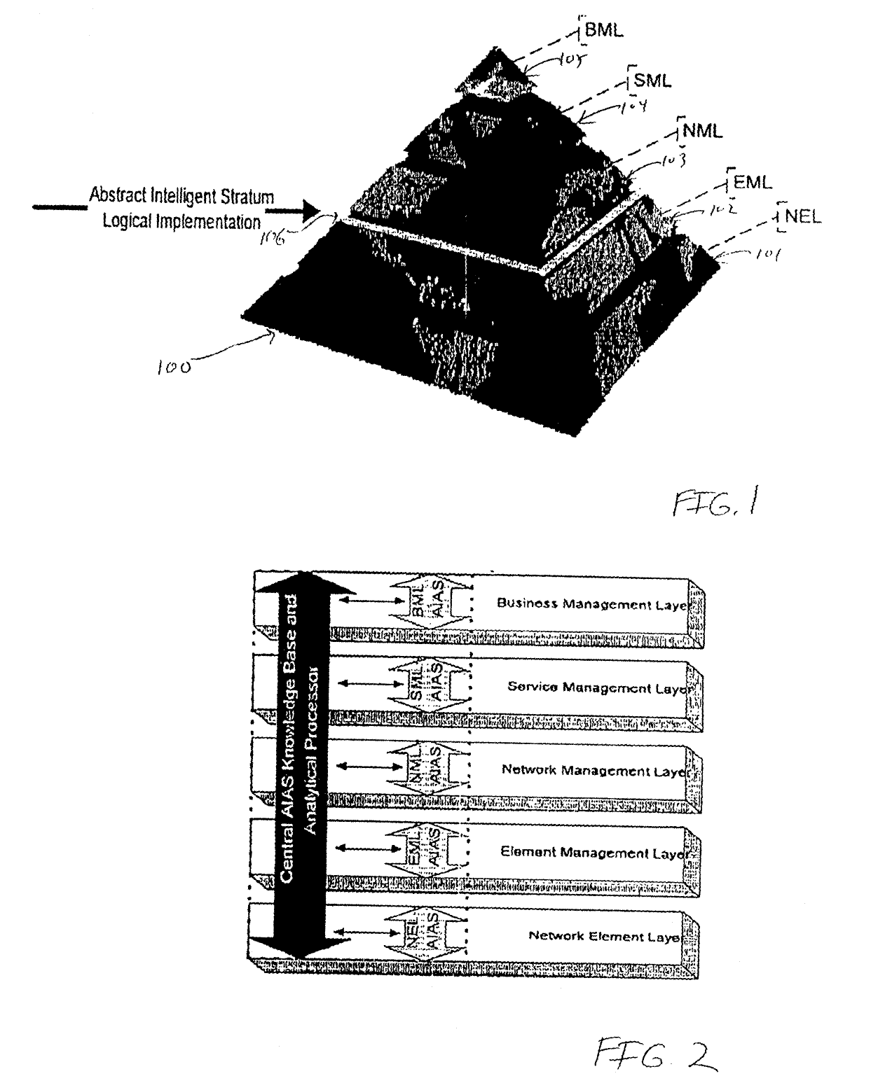

Those skilled in the art will readily appreciate the characterization of an exemplary prior art TMN model, shown as model 100 in FIG. 1 (without the introduction of the AIS as contemplated by the invention), as containing five independent domains with the capability to pass data.

The depicted model (the prior art portion thereof) is shown to specifically include Network Element Layer 101; Element Management Layer 102, Network Management Layer 103; Service Management Layer 104; and Business Management Layer 105.

The existing TMN infrastructure and strategy are based an deploying of telecommunications services. To this end, the methods, strategies and tools modify the following concerns:

1. The linear implementation of GDMO objects (models and methods) that currently support TMN.

2. The communication interfaces defined within the TMN layers. Each application functioning within a given layer, for different services being assured a singular method of interaction.

3. Each subordinate layer (e.g. the Network Element Layer 101 is subordinate to the Element Management Layer) acts as a data collector instead of a true “management” layer.

TMN platforms are currently the “best fix” infrastructure to provide the basic framework for an environment capable of supporting future requirements for business operations and interoperability. While TMN standards are rich in features and object models, they lack (as explained hereinbefore) the necessary advanced analysis capabilities to effectively manage complex information.

Each application operating within a specific TMN layer analyzes its own data. Results are not shared with other sibling applications that would create a more robust and informed decision making or information handling process. Without such interaction and learning, the platform is left in an inflexible state. Each layer and application within the layer continues to act independent of the “experience” or knowledge of other applications.

According to the invention, an enhanced, intelligent TMN platform is pioneered on the principle of a human learning process, where each new experience has a forced (tightly or loosely coupled) relationship with past experiences of related or like kinds.

In order to provide the desired features of the invention, an intelligent TMN is described which integrates Adaptive Enterprise Management (AEM). AEM involves the introduction into TMN model 100 (shown in FIG. 1) of an Abstract Intelligent Stratum (AIS), shown as 106 in FIG. 1; together with the introduction of Neural Objects, Neurocele, an Intelligent Object Request Broker; a Knowledge Base Brokers and Impulse Communications Messaging, all to be defined in greater detail hereinafter.

Abstract Intelligent Stratum (AIS) layer 106 shown in FIG. 1 is a proactive methodology that provides cross-boundaries analytical services and knowledge domains.

The content of AIS layer 106 provides context between layers in TMN model 100. This element is critical to the evolution of TMN. Context is preserved in an environment, not just a state, which associates multiple rules and objects. It is within this domain that objects “live”.

A “live” object is one that has an active transition state. Its history is maintained within the AIS environment.

In the current TMN model, objects are used to convey data and methods that operate on a closed repository of information. Analysis is confined and constrained. Conclusions and results can only be based on limited information, or a single experience.

The AIS domain uses vast inputs of both related and unrelated information to offer unsolicited conclusions and recommendation to the next stratum and the object itself. This functionality provides Impulse Communication Messaging (ICM) a mechanism to correlate experiences across the entire Infrastructure.

According to a preferred embodiment of the invention, the AIS employs fuzzy logic to be the sensory element for all weighting processes and Impulse Communications Messaging (ICM), to be described in detail hereinafter, provides the message framework environment.

Each of the aforementioned aspects of AEM will now be described in detail.

### Advanced Intelligent Analysis Service

The present TMN infrastructure is void of an integrated set of services utilized by all layers in support of applications operating in each individual layer. As previously pointed out, the infrastructure lacks continuity in its operations and its analytical abilities.

According to the invention, Advanced Intelligent Analysis Services (AIAS) is a family of intelligent elements: (a) object request brokers; (b) analytical servers; (c) data and experience images; (d) a processing element (or elements); (e) interaction rules; and a knowledge base.

Implementing this strategy ensures that every n (where n is greater than 0) functional component of the platform is capable of interacting with every m (where m is greater or equal to 0) component.

Currently, messages or objects are passed from one layer to the next logical layer. As a result, no interactions exist between non-contiguous layers. A central AIAS module is the master-processing element for all “experiences”. As it is exposed to more activities and events, a server has the ability to expand (matures, splits) into an exact duplicate of itself.

When a server splits or matures, it creates a smaller repository of related states or experiences. Splits ensure that processing time and overall system performance is always optimal for each analytical unit. The time does not exceed the maximum threshold for processing an average size “experience”. Each split represents a level or age (knowledge acquired and time). The degree to which the server is capable of making a decision or weighting an experience is directly related to its age factor.

For example, an AlAS matures, resulting in two sibling servers A and B. A set of rules, enforced by n knowledge-bases, indicates that A has “lived” longer and has been exposed to more information than B, thus able to make use of more sophisticated rules and algorithms to formulate a conclusion. Sibling A employs more logic or in-depth reasoning to its experience than would B. Over time Object B will come to the same conclusion about a simple experience as A.

Each TMN layer has its own set of intelligent servers. An AIAS component is implemented at each TMN layer. This may be seen with reference to FIG. 2.

With multiple interconnections to the central AIAS. objects are processed in near realtime processing. The input elements to the AIAS are experiences and neuro-objects. This may result from any part of the platform, in particular other AIASs.

Messages are delivered by the platform's ICM mechanism (discussed hereinafter). The AIAS not only collects analytical information, but with the inclusion of forecast Artificial Intelligence servers components (contemplated by the invention), a mechanism is would be available to identify services that the network is capable of providing without marketing requirements or research.

### Neural Objects

According to the invention, the fundamental data element of AEM is called a Neural Object (neuro-object). A neuro-object is the smallest “life” in AEM. Based on a new object model for data modeling and representation, it is the input to the AIAS. It has meaning to all ALAS services. The purpose of the Neural-object (N-object) is to provide:

1) a mechanism whose storage capacity exceeds traditional technology and data volume limitations;

2) a data source for real-time analysis; and

3) a data element that can be passed efficiently throughout the infrastructure exchanging actions and specific experiences.

N-objects maintain their own associations. The N-object is the basic record used to provide the platform with its data-mining repository. Collectively, they are the knowledge base at each level. N-objects are themselves processes, enabling it to interact with other N-objects.

N-objects provide the basic weights and sanitized-data. Together with exchange neurons (weighted values), neuro-objects move throughout the communications path allowing the individual service to either experience (learn from its content) or dismiss (the primary requester can conclude that the experience is not noteworthy and destroy it).

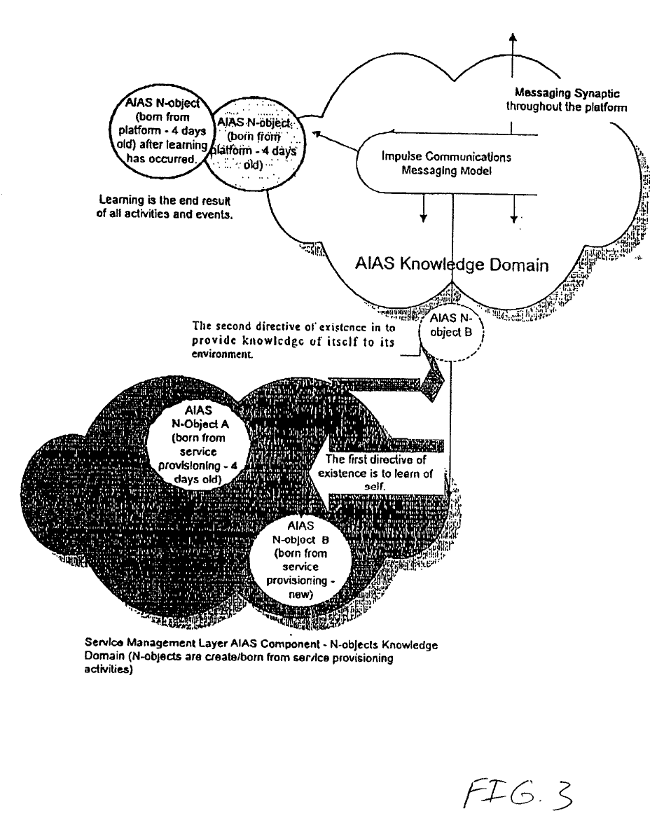

When a neuro-object is instantiated from an AIS, information about its reason for existence and the environment is gained by its exposure to other “siblings”, as illustrated in FIG. 3.

This functionality supports the Business Management Layer AIAS capability to create/suggest/manage more sophisticated services offering without modeling.

A Neural Object is the mechanism that ICM utilizes to sustain the life of the platform. At all times a neuro-object is on a path to some part of the platform.

### Neuro-Message Cells

The neurocele (nc), the smallest entities of data for the ICM, is the nucleus of every neuro-object. Each nc carries specific data or transaction content. The content on the nc determines how one neuro-object responds to another and what type of neuro-object is created. Neuroceles are integration interface points for all applications on the platform.

When an application is registered with its local AIAS, a neuro-object is born. As a result a nc in a neuro-object is forwarded to its parent AIAS then to the central AIAS by way of the ICM. The neuro-object is instantiated with instructions on its role and how it is to interact within the platform. “Plug and play” capabilities are provided to the platform by ncs. Adherence to a basic and standardized interface, each new application enhances its own functionality.

### Intelligent Object Request Broker

The backbone to any expert system, is its inference engine (the software that processes the rules and data, then decides the next appropriate action). This is this function of the Intelligent Object Request Broker (IORB) server. The knowledge base of the platform and each of the layers are now able to form conclusions about customer preferences, requests, service orders, even provisioning strategies and decisions.

The IORB is the traffic manager of all neuro-objects. According to the invention, this functionality is supported by a fuzzy logic operating system (FLOPS).

According to a preferred embodiment of the invention, FLOPS comes with two inference engines: serial FLOPS, which fires its rules one at a time; and parallel FLOPS, which fires all fireable rules effectively simultaneously.

Using fuzzy systems theory, it is possible to qualify all data with a confidence weight of some varying degree of truth. For specific data, which satisfy the antecedent (more or less), the inference process will compute the confidence that the entire antecedent (left hand side or “LHS”) is true. This antecedent confidence, together with the confidence in the rule itself, will become the confidence with which actions specified by the consequent (right hand side or “RHS”) are taken.

In particular, any data modified or created by the consequent will have that confidence attached. It is on this basis that the IORB obligates a neuro-object to a particular AIAS component or neuro-object.

For the IORB, fuzzy logic offers a better way of representing reality (for example, the state of any service order, the impact of an unsolicited alarm, or billing situation, etc.). Using fuzzy logic, a statement is true to various degrees, ranging from completely true through half-truth to completely false. These allow results to be multi-valued. With various state degrees, superior decisions and conclusions can be drawn when services are conceived or requested.

The basic idea of multi-valued logic is known. However, multi-value logic concepts have not been applied the evolution of service offerings, network management, work order management, nor billing. This strategy offers complete flexibility in analytical evaluations, platform and network performance evaluations, establishing and tracking business goals, and application interoperability.

### Knowledge-Base Broker

According to the invention, the Knowledge Base Broker (KBB) is a repository of decentralized data and results. It provides persistence storage for real time processing for the neuro-object.

The KBB creates an environment to formulate the best analysis possible at any given time, and updates the platform of every transaction. The time for a FLOPS program to process a data item is highly application-specific.

Set forth hereinafter is a formula for approximating processing time per object:

Processing time per object in milliseconds=processor speed*Number of rules to be scanned for fireability*number of nms concurrently processed+(1.5*average disk access time)

The precise throughput in data items per second will, of course, depend also the complexity of the date items and the complexity of the rules; more complex rules require longer to scan for fireability.

Services in TMN, appearing in the form of mathematics formulas, can be designed to produce a leaning environment within the guidelines of expert systems and an analysis can be formulated.

### Impulse Communications Messaging

The ability of a system to share information enables the accompanying application to exercise 90% of its features. With the integration of “best in class” applications, flexibility and functionality are decreased. A complete and comprehensive messaging mechanism is required to gain the benefits of implementing a TMN platform.

Impulse Communications Messaging (ICM) is a strategy that provides a completely open platform where any system can be seamlessly integrated without loosing functionality.

ICM is dual level, peer-to-peer messaging. Messages are received and delivered via neuro-object entities. A neuro-object element contains one or more nm entities. Each AIAS component, central or parent, receives a “version” of the Neuro-object element. The messaging infrastructure resides throughout the complete platform.

ICM utilizes a messaging algorithm, in conjunction with rule base and knowledge base servers, supporting the receipt and delivery of all messages. Solicited messages do not exist within the messaging framework. Each message represents a broadcast to the framework infrastructure.

The infrastructure is capable of managing ncs. Once a Neuro-object has been created or born, it is dispatched to its parent AIAS. For example, an unsolicited alarm is received, as depicted in FIG. 4, a nc is created and forwarded to the outer layer of the ICM resulting in an instantiated Neuro-object. (It should be noted that an unsolicited alarm captured from a network device or EMS, is different for the unsolicited from within the infrastructure). The N-object is immediately place on the inbound queue of its AIAS.

The AIAS contains the knowledge and the rule by which the Neuro-object can exist and what other component has an interest in its type. The path of a Neuro-object is established for only an instance in time. The next one of its type may take a different yet fixed path throughout the platform.

The ICM having dual level is able to receive and deliver messages simultaneously. Each level contains bi-directional paths where priority Neuro-objects can be passed. Each AIAS at the parent level has dual paths to the central AIAS. This allows messages destined for specific applications to be forwarded unblocked.

What is claimed is

1. An intelligent Telecommunications Management Network (TMN) platform, comprising:
(a) a multilayer TMN platform; and
(b) means for providing cross-boundary analytical services and knowledge domains in said multilayer TMN platform.

2. Apparatus as set forth in claim 1 wherein said means for providing cross-boundary analytical services and knowledge domains in said multilayer TMN platform utilizes neuro-object elements which are capable of learning.

3. Apparatus as set forth in claim 1 wherein said means for providing cross-boundary analytical services and knowledge domains further comprises an abstract intelligent stratum within said TMN platform which provides context between said layers in an environment which associates multiple rules and objects.

4. Apparatus as set forth in claim 1 further comprising means for providing a seamless open platform without loss of functionality, wherein the means for providing said seamless open platform further comprises an impulse communications messaging system.

5. Apparatus as set forth in claim 4 wherein said impulse communications messaging system is a dual level, peer to peer messaging system that receives and delivers messages utilizing neuro-object elements which are capable of learning.

6. Apparatus as set forth in claim 5 wherein each neuro-object element contains at least one neuro message cell capable of carrying specific data or transaction content.

7. An intelligent Telecommunications Management Network (TMN), comprising:
(a) a multilayer TMN platform; and
(b) means for providing an integrated set of services utilized by all layers in said TMN platform in support of applications operating at each individual layer.

8. Apparatus as set forth in claim 7 wherein said means for providing an integrated set of services further comprises:
(a) a centralized Advanced Intelligent Analysis Services (AIAS) database; and
(b) an analytical processor.

9. Apparatus as set forth in claim 8 further comprising a set of neuro-object elements which are capable of learning.

10. Apparatus as set forth in claim 7 wherein said means for providing an integrated set of services further comprises a family of intelligent elements.

11. Apparatus as set forth in claim 10 wherein said family of intelligent elements further comprises a plurality of intelligent object request brokers.

12. Apparatus as set forth in claim 10 wherein said intelligent object request brokers are implemented utilizing at least one fuzzy logic operating system.

13. Apparatus as set forth in claim 10 wherein said family of intelligent elements further comprises a plurality of analytical servers.

14. Apparatus as set forth in claim 10 wherein said family of intelligent elements further comprises a set of interaction rules.

15. Apparatus as set forth in claim 7 wherein said means for providing an integrated set of services further comprises means for creating data and experience images.

16. An intelligent Telecommunications Management Network (TMN), comprising:
(a) a multilayer TMN platform;
(b) means for providing cross-boundary analytical services and knowledge domains in said multilayer TMN platform;
(c) means for providing an integrated set of services utilized by all layers in said TMN platform in support of applications operating at each individual layer; and
(d) a set of neuro-object elements, each element being capable of learning.

17. An intelligent Telecommunications Management Network (TMN), comprising:
(a) a set of neural objects;
(b) a plurality of fuzzy logic servers;
(c) a plurality of artificial intelligent servers; and
(d) an Abstract Intelligence Stratum (AIS) included as part of the TMN.

18. A method for performing Adaptive Enterprise Management (AEM) in a multilayer Telecommunications Management Network (TMN) platform, comprising the steps of:
(a) providing cross-boundary analytical services and knowledge domains in said multilayer TMN platform; and
(b) providing an integrated set of services utilized by all layers in said TMN platform in support of applications operating at each individual layer.

19. A method as set forth in claim 18 further comprising the step of defining a set of neuro-object elements, each element being capable of learning and has an active transition state.

20. A method as set forth in claim 19 wherein said step of defining a set of neuro-object elements further comprises the step of including within each neuro-object element at least one neuro message cell capable of carrying specific data or transaction content.

21. A method as set forth in claim 19 wherein each of said neuro-object elements has an associated object history that is maintained in said knowledge domain.

22. A method for performing Adaptive Enterprise Management (AEM) in a multilayer Telecommunications Management Network (TMN), comprising the steps of:
(a) defining a set of neuro-object elements, each element being capable of learning, wherein each element includes at least one neuro message cell capable of carrying specific data or transaction content; and
(b) introducing an Abstract Intelligence Stratum (AIS) layer into said multilayer TMN, for providing cross-boundary analytical services and knowledge domains in said multilayer TMN platform.

23. A method as set forth in claim 22 further comprising the step of utilizing said AIS to provide context between the layers in said multilayer TMN in an environment which associates multiple rules and objects.

24. A method as set forth in claim 22 wherein each of said neuro-object elements has an associated object history that is maintained in said knowledge domain.

25. A method as set forth in claim 24 further comprising the step of correlating experiences across the entire TMN infrastructure utilizing said knowledge domain.

26. A method as set forth in claim 22 further comprising the step of introducing Advanced Intelligent Analysis Services (AIAS) into said multilayer TMN, for providing an integrated set of services utilized by all layers in said TMN platform in support of applications operating at each individual layer.

27. A method as set forth in claim 26 wherein said step of introducing AIAS into said multilayer TMN further comprises the step of providing each TMN layer with its own set of intelligent servers, thereby implementing an AIAS component at each TMN layer.

28. A method as set forth in claim 27 further comprising the step of interconnecting each TMN layer to a central AIAS processor to facilitate object processing approximately in real time.

29. A method as set forth in claim 28 further comprising the step of inputting experiences and neuro-objects to said central AIAS processor from any part of the TMN platform.

30. A method as set forth in claim 29 further comprising the steps of:
(a) utilizing fuzzy logic as a sensory element for weighting processes used to perform AEM in said multilayer TMN; and
(b) utilizing Impulse Communications Messaging (ICM), as a message framework environment in said multilayer TMN.
